(19) United States
(12) Patent Application Publication
(10) Pub. No.: US 2016/0207349 A1
(43) Pub. Date: Jul. 21, 2016

(54) ARTIFICIAL TREE

(71) Applicant: Ulta-Lit Tree Co., Glenview, IL (US)

(72) Inventors: John DeCosmo, Glenview, IL (US); Anthony DeCosmo, San Antonio, FL (US); Lorenzo Squarci, Newburgh, NY (US)

(21) Appl. No.: 14/600,216

(22) Filed: Jan. 20, 2015

(51) Int. Cl. B44C 5/06; A41G 1/00

(52) U.S. Cl. CPC B44C 5/06; A41G 1/00

(57) ABSTRACT

A method of forming artificial needles in an elongated planar strip of plastic material to be formed into artificial tree branches, comprises bending longitudinal edge portions of the strip out of the plane of the strip progressively along the length of the strip, and slitting longitudinal edge portions of the strip, including the bent portions of the strip and portions of the strip adjacent the bent portions, in a direction transverse to the length of the elongated strip, to form artificial needles. The strip is preferably advanced continuously along a bending tool to bend the longitudinal edge portion. The longitudinal edge portion of the strip may be heated prior to or during the bending of the edge portion to reduce spring back.

### FIELD OF THE INVENTION

The present invention relates to artificial trees and, more particularly, to the fabrication of artificial tree branches that contain needles that simulate those on the branches of coniferous or evergreen trees.

### BRIEF SUMMARY

In accordance with one embodiment, a method of forming artificial needles in an elongated planar strip of plastic material to be formed into artificial tree branches, comprises bending longitudinal edge portions of the strip out of the plane of the strip progressively along the length of the strip, and slitting longitudinal edge portions of the strip, including the bent portions of the strip and portions of the strip adjacent the bent portions, in a direction transverse to the length of the elongated strip, to form artificial needles. The strip is preferably advanced continuously along a bending tool to bend the longitudinal edge portion. The longitudinal edge portion of the strip may be heated prior to or during the bending of the edge portion to reduce spring back. In one implementation, the longitudinal edge portions of the strip are bent out of the plane of the strip by an angle of between about 45 degrees and about 135 degrees from the plane of the strip.

In accordance with another embodiment, an elongated strip of plastic material forming artificial needles in artificial tree branches for artificial coniferous trees has at least one longitudinal edge portion bent out of the plane of the strip along the length of the strip. Longitudinal edge portions of the strip, including the bent portions of the strip and portions of the strip adjacent said bent portions, are slit in a direction transverse to the length of the elongated strip, to form artificial needles. In one implementation, the longitudinal edge portion is bent out of the plane of the strip at an angle of between about 45 degrees and about 135 degrees. In another implementation, opposite longitudinal edge portions of the strip are bent in opposite directions out of the plane of the strip, and both of the longitudinal edge portions, including the bent portions of the strip and portions of the strip adjacent the bent portions, are slit in a direction transverse to the length of the elongated strip, to form artificial needles. The longitudinal edge portion of the strip may be heated prior to or during the bending of the edge portion to reduce spring back.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

FIG. 1 is a side elevation of an artificial tree having branches with artificial needles embodying the design of the present invention.

FIG. 2 is an enlarged top plan view of one of the artificial needles included in the branches of the artificial tree illustrated in FIG. 1, with the end portion of the needle bent upwardly.

FIG. 3 is a side elevation of the needle of FIG. 2.

FIG. 4 is a bottom plan view of the needle of FIGS. 2 and 3.

FIG. 5 is the same side elevation shown in FIG. 3 with the needle rotated 180 degrees around a horizontal axis so that the end portion of the needle is bent downwardly.

FIG. 6 is a left side elevation of the needle of FIGS. 2-4.

FIG. 7 is a right side elevation of the needle of FIGS. 2-4.

FIG. 8 is a perspective view of a first embodiment of a plastic strip being formed prior to the cutting of the needles and prior to the use of the plastic strip in forming one of the branches shown in FIG. 1.

FIG. 9 is a section taken along line 9-9 in FIG. 8.

FIG. 10 is a section taken along line 10-10 in FIG. 8.

FIG. 11 is a section taken along line 11-11 in FIG. 8.

FIG. 12 is a section taken along line 12-12 in FIG. 8.

FIG. 13 is a perspective view of a second embodiment of a plastic strip being formed prior to the cutting of the needles and prior to the use of the plastic strip in forming one of the branches shown in FIG. 1.

FIG. 14 is a section taken along line 14-14 in FIG. 13.

FIG. 15 is a section taken along line 15-15 in FIG. 13.

FIG. 16 is a section taken along line 16-16 in FIG. 13.

While the present disclosure is susceptible to various modifications and alternative forms, specific embodiments and implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the inventions as defined by the appended claims.

### DETAILED DESCRIPTION

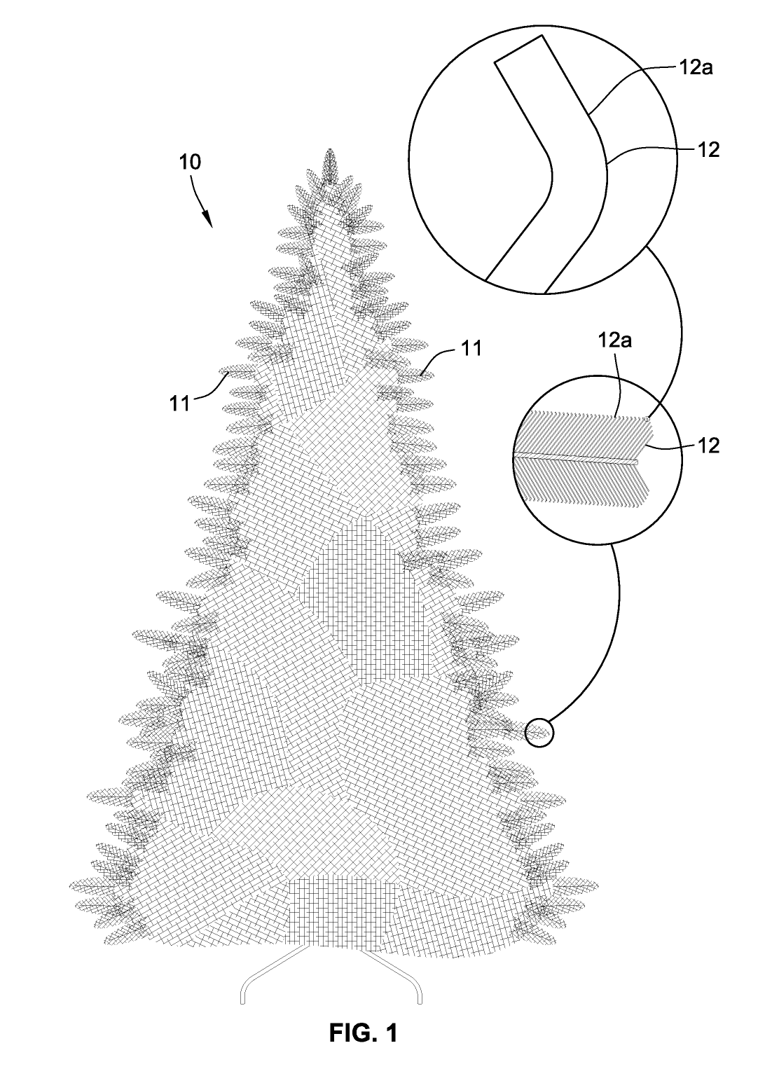

Turning now to the drawings and referring first to FIG. 1, an artificial coniferous tree 10 includes multiple branches 11 that are typically formed from strips of plastic or polymeric material (e.g., PVC) that is cut to form a multiplicity of artificial needles, and then wrapped around wires that can be attached to a supporting frame and oriented at different angles to form an artificial tree. Artificial trees of this type are typically used Christmas trees, and particularly “pre-lit” Christmas trees that are permanently equipped with decorative lights and other ornaments. The artificial needles of these trees are often abraded to give them a more natural look, or even sprayed to simulate a covering of snow or other decorative material.

In accordance with the present invention, the artificial needles are

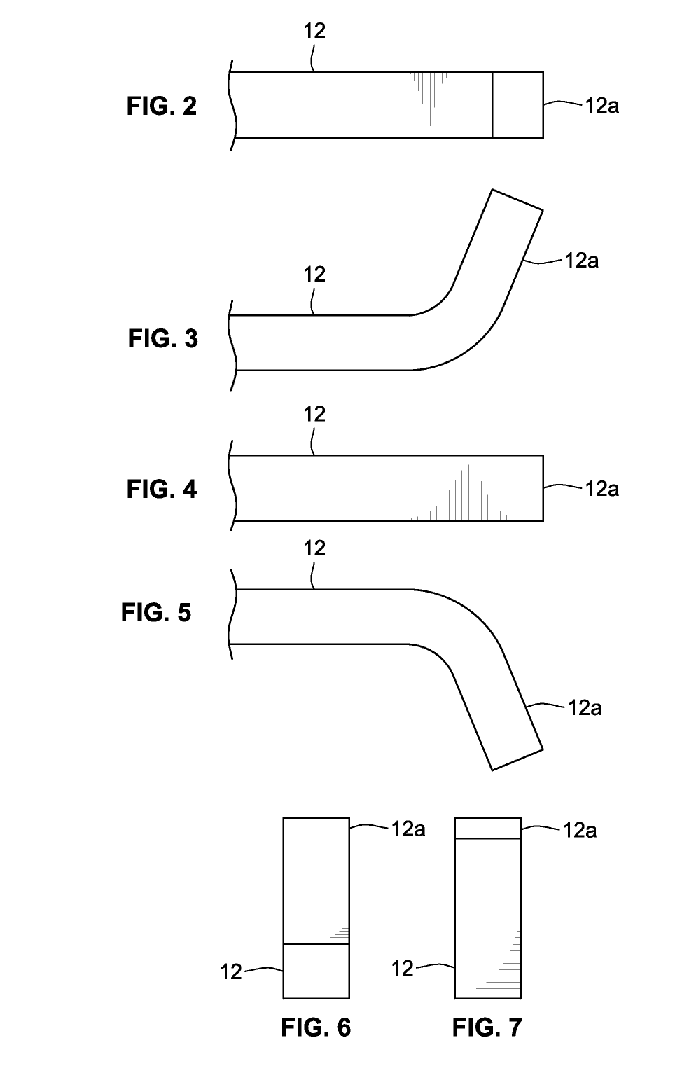

In FIGS. 1-7, the tips of the illustrative needles 12 are bent at an angle of about 80° from the plane of the central portion of the plastic strip 13 from which the needles 12 are formed. However, the angle at which the needle tips 12a are bent can vary over a wide range, extending at least over the range from about 45° to about 135° from the plane of the plastic strip 13. The length of the portion that is bent can also very over a wide range, e.g., from about 5% to about 15% of the length of the needle 12.

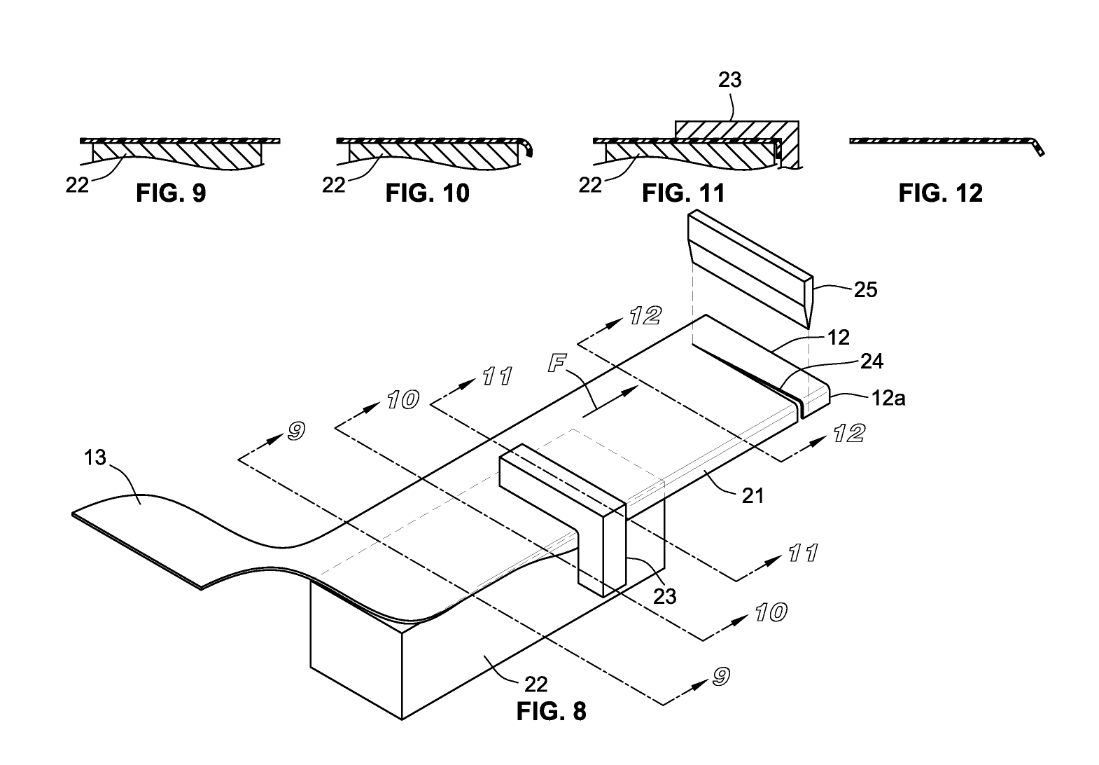

FIGS. 8-12 illustrate an example in which needles 12 are formed along one longitudinal edge 20 of a plastic strip 13 by bending a longitudinal edge portion 21 of the strip at an angle of about 90° from the main body portion of the strip. The bending is effected by advancing the plastic strip 13 in the direction of the arrow F along the top surface of a die block 22 and under an L-shaped tool 23 spaced slightly away from the top longitudinal corner of the block 22. The tool 23 bends the longitudinal edge portion 21 of the strip downwardly along a sidewall of the die block 22. The strip is then cut transversely at 24 by a knife 25 to form the needles 12. These transverse cuts 24 are repeated at regular intervals as the strip 13 traverses the knife 25, with the lengths of the intervals determining the widths of the needles 12. The resulting strip is then twisted around one or more wires to form an artificial coniferous tree branch with the needles projecting in generally radial directions from the one or more wires, as is already known in the art of forming artificial trees.

The plastic strip 13 may be heated prior to or during the bending, to control the extent to which the bent portion springs back after passing the tool 23. For example, FIG. 11 shows that the tool 23 bends the edge portion 21 downwardly at an angle of 90° and then FIG. 12 shows that the edge portion 21 springs back slightly when it is no longer engaged by the tool 23. It is this spring-back that can be reduced by heating at least the edge portion 21 of the plastic strip 13 prior to or during the bending of the side portion 21.

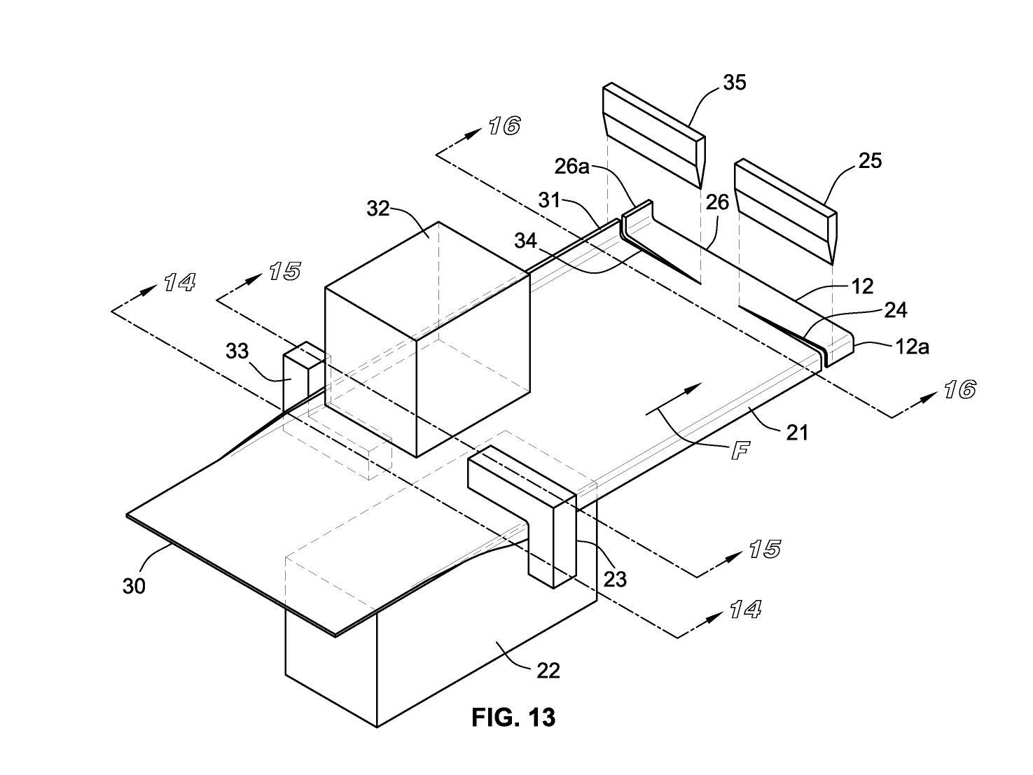

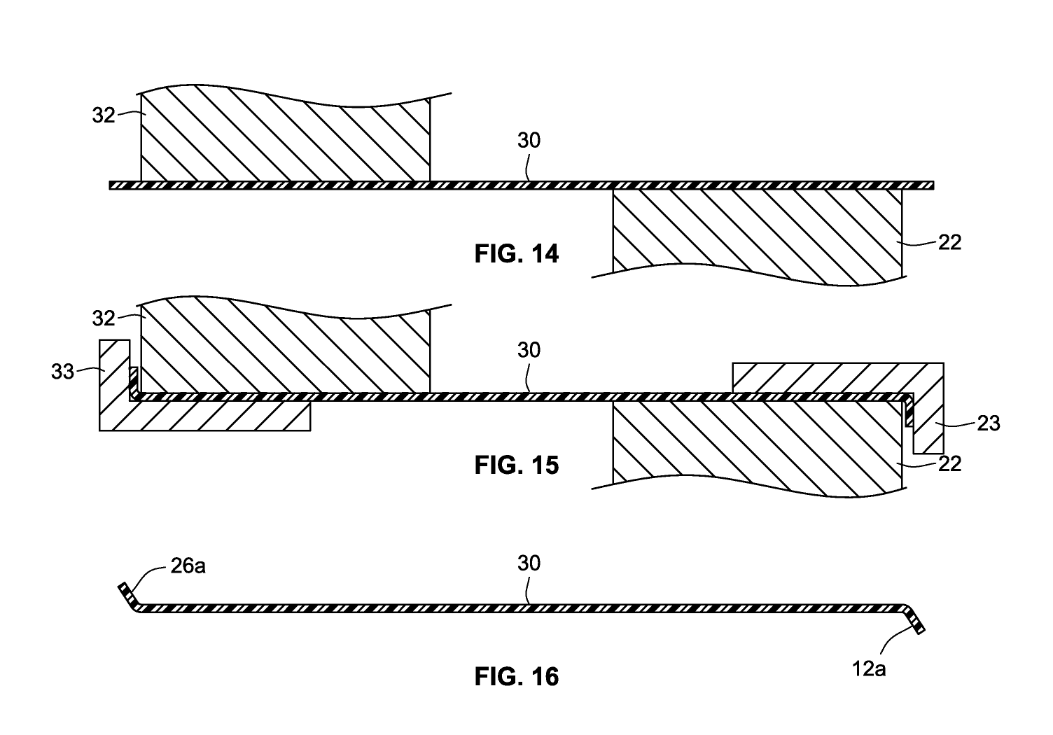

FIGS. 13-16 illustrate a modified embodiment in which two dies 22 and 32, two tools 23 and 33, and two knives 25 and 35 are used to form bent-end needles 12 and 26 in both longitudinal edges of a plastic strip 30. The die block 22 and tool 23 bend the first edge portion 21 downwardly along the first longitudinal edge of the strip 30 in which needles 12 are cut by the knife 25, as described above in connection with FIGS. 8-12. The second die bock 32 and tool 33 bend a second edge portion 31 upwardly along the second longitudinal edge of the strip 30, and then a second knife 35 forms successive cuts 34 in the strip 30 to form a second set of needles 34 with upwardly bent end portions 26a. The resulting strip is then twisted around one or more wires to form an artificial coniferous tree branch with the needles projecting in generally radial directions from the one or more wires, as is already known in the art of forming artificial trees.

Here again, the plastic strip 30 may be heated prior to or during the bending, to control the extent to which the bent edge portions 21 and 31 spring back after passing the respective tools 23 and 33. For example, FIG. 15 shows that the tools 23 and 33 bend the edge portions 21 and 31 downwardly and upwardly at angles of 90°, and then FIG. 16 shows that the edge portions 21 and 31 spring back slightly when they are no longer engaged by the respective tools 23 and 33. It is this spring-back that can be reduced by heating at least the edge portions 21 and 31 of the plastic strip 30 prior to or during the bending of the edge portions 21 and 31.

While particular embodiments, aspects, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A method of forming artificial needles in an elongated strip of plastic material to be formed into artificial tree branches, said method comprising
bending at least one of the longitudinal edge portions of said strip out of the plane of the strip progressively along the length of the strip, and
slitting longitudinal edge portions of said strip, including the bent portions of said strip and portions of said strip adjacent said bent portions, in a direction transverse to the length of the elongated strip, to form artificial needles.

2. The method of claim 1 in which said longitudinal edge portion is bent out of the plane of said strip at an angle of between about 45 degrees and about 135 degrees.

3. The method of claim 1 in which opposite longitudinal edge portions of said strip are bent in opposite directions out of the plane of said strip, and both of said longitudinal edge portions, including the bent portions of said strip and portions of said strip adjacent said bent portions, are slit in a direction transverse to the length of the elongated strip, to form artificial needles.

4. The method of claim 1 in which said longitudinal edge portion of said strip is heated prior to or during the bending of said edge portion to reduce spring back.

5. The method of claim 1 in which said strip is advanced continuously along a bending tool to bend said longitudinal edge portion.

6. An elongated strip of plastic material forming artificial needles in artificial tree branches for artificial coniferous trees, said strip comprising
at least one longitudinal edge portion bent out of the plane of the strip along the length of the strip, and
longitudinal edge portions of said strip, including the bent portions of said strip and portions of said strip adjacent said bent portions, being slit in a direction transverse to the length of the elongated strip, to form artificial needles.

7. The elongated strip of plastic material of claim 6 in which said longitudinal edge portion is bent out of the plane of said strip at an angle of between about 45 degrees and about 135 degrees.

8. The elongated strip of plastic material of claim 6 in which opposite longitudinal edge portions of said strip are bent in opposite directions out of the plane of said strip, and both of said longitudinal edge portions, including the bent portions of said strip and portions of said strip adjacent said bent portions, are slit in a direction transverse to the length of the elongated strip, to form artificial needles.

9. The elongated strip of plastic material of claim 6 in which said longitudinal edge portion of said strip is heated prior to or during the bending of said edge portion to reduce spring back.
